(19) United States
(12) Patent Application Publication
(10) Pub. No.: US 2016/0333831 A1
(43) Pub. Date: Nov. 17, 2016

(54) FUEL REFORMING APPARATUS

(71) Applicant: HONDA MOTOR CO., LTD., Tokyo (JP)

(72) Inventors: Tomohide KUDO, Wako (JP); Kohtaro HASHIMOTO, Wako (JP)

(73) Assignee: HONDA MOTOR CO., LTD., Tokyo (JP)

(21) Appl. No.: 15/089,593

(22) Filed: Apr. 4, 2016

(30) Foreign Application Priority Data
May 12, 2015 (JP) 2015-097542

(51) Int. Cl. F02M 27/02; C10L 10/02; C10L 10/10; F02M 25/00; F02M 33/00

(52) U.S. Cl. CPC F02M 27/02; F02M 25/00; F02M 33/00; C10L 10/10; C10L 10/02; C10L 2290/24; C10L 2270/026; C10L 2270/023; C10L 2290/143; C10L 2290/145; C10L 2290/46; C10L 2290/58; C10L 2290/562; C10L 2200/0423; C10L 2200/0446

(57) ABSTRACT

A mixer to mix a fuel with air includes plural fluid inlets, at least one fluid outlet, a casing, a plurality of stirring blades, and a particle material or a porous material. The casing has a substantially tubular shape extending in an axial direction of the casing between the plural fluid inlets and the at least one fluid outlet. The plurality of stirring blades are provided in the casing to align in the axial direction so that a torsional turning direction of the plurality of stirring blades is sequentially reversed in an order of alignment. The particle material or a porous material is disposed in the casing to fill an entire space containing the plurality of stirring blades from the plural fluid inlets to the at least one fluid outlet. Sizes of gaps existing in the entire space are less than a quenching distance of the fuel.

### CROSS-REFERENCE TO RELATED APPLICATIONS

The present application claims priority under 35 U.S.C. §119 to Japanese Patent Application No. 2015-097542, filed May 12, 2015, entitled “Fuel Reforming Apparatus and Mixer Used for The Apparatus.” The contents of this application are incorporated herein by reference in their entirety.

### BACKGROUND

1. Field of the Invention

The present disclosure relates to a fuel reforming apparatus.

2. Discussion of the Background

As well known, antiknock quality is an important property required for fuel for gasoline engines. A value of the antiknock quality is generally represented by an octane number. Fuel with a high octane number is particularly desired for recent high-compression-ratio engines.

A method of retarding ignition timing is used for suppressing knocking of an engine under the fuel condition of a constant octane number. However, retarding the ignition timing decreases the thermal efficiency of an engine. Therefore, there is demand for developing a technique for achieving high thermal efficiency while suppressing knocking.

In addition, it is already known that harmful lead or the like is not added for increasing an octane number of gasoline and a proper amount of alcohol (for example, methanol) is added for decreasing harmful substances contained in engine exhaust gas (see, for example, the specification of U.S. Pat. No. 4,244,328).

On the other hand, a technique according to the present disclosure described below includes providing a mixer that mixes air and gasoline at a stage before a reformer that catalytically reforms the gasoline in a conversion process for converting the gasoline mainly composed of hydrocarbons into alcohols on a vehicle. In general, various mixers that mix two fluids in a continuous flow have been proposed (see, for example, Japanese Unexamined Patent Application Publication No. 4-193337).

### SUMMARY

According to one aspect of the present invention, a fuel reforming apparatus reforms a fuel mainly composed of hydrocarbons by using air and generates alcohols. The fuel reforming apparatus includes a reformer containing a reforming catalyst that reforms the fuel mainly composed of hydrocarbons by using air and generates alcohols, a mixer that is provided on the upstream side of the reformer and mixes the fuel with air and supplies the mixture to the reformer, and a condenser that is provided on the downstream side of the reformer and separates the gas produced from the reformer into a condensed phase mainly composed of the reformed fuel and a gas phase. The mixer includes two or more fluid inlets and one or more fluid outlets, a casing with a substantially tubular shape as a whole extending in the axial direction between the fluid inlets and the fluid outlets, a plurality of fixed stirring blades provided to align in the axial direction in the casing so that the torsional turning direction is sequentially reversed in the order of alignment, and a particle material or a porous material disposed to fill the entire remaining space of a housing part that is set to house at least the plurality of fixed stirring blades in a space including the inside of the casing and that extends from the fluid inlets to the fluid outlets. The size of gaps produced in the entire remaining space in which the particle material or porous material is disposed is less than the quenching distance of the fuel supplied from the fluid inlets.

According to another aspect of the present invention, a fuel reforming apparatus includes a reformer, a condenser, and a mixer. The reformer includes a reforming catalyst to reform a fuel including a hydrocarbon using air to produce gas for obtaining an alcohol. The condenser is to separate the gas produced by the reformer into a gas phase and a condensed phase which includes reformed fuel. The mixer is to mix the fuel with air to produce a mixture which is supplied to the reformer. The mixer includes plural fluid inlets, at least one fluid outlet, a casing, a plurality of stirring blades, and a particle material or a porous material. The casing has a substantially tubular shape extending in an axial direction of the casing between the plural fluid inlets and the at least one fluid outlet. The plurality of stirring blades are provided in the casing to align in the axial direction so that a torsional turning direction of the plurality of stirring blades is sequentially reversed in an order of alignment. The particle material or a porous material is disposed in the casing to fill an entire space containing the plurality of stirring blades from the plural fluid inlets to the at least one fluid outlet. Sizes of gaps existing in the entire space are less than a quenching distance of the fuel supplied from the plural fluid inlets.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a drawing showing a configuration of a fuel reforming apparatus according to an embodiment of the present application.

FIG. 2 is a cross sectional side view of a mixer in an aspect used in the fuel reforming apparatus shown in FIG. 1.

FIG. 3 is an exploded perspective view of the mixer shown in FIG. 2.

FIG. 4 is an enlarged schematic view showing a portion of the mixer shown in FIG. 2.

FIG. 5 is an enlarged schematic view showing a corner in a housing part of the mixer shown in FIG. 2.

FIG. 6 is a cross sectional side view of a mixer in another aspect used in the fuel reforming apparatus shown in FIG. 1.

FIG. 7 is an enlarged perspective view of a portion of the mixer shown in FIG. 6.

### DESCRIPTION OF THE EMBODIMENTS

The embodiments will now be described with reference to the accompanying drawings, wherein like reference numerals designate corresponding or identical elements throughout the various drawings.

The preset application is made clear by describing an embodiment of the present application in detail below with reference to the drawings.

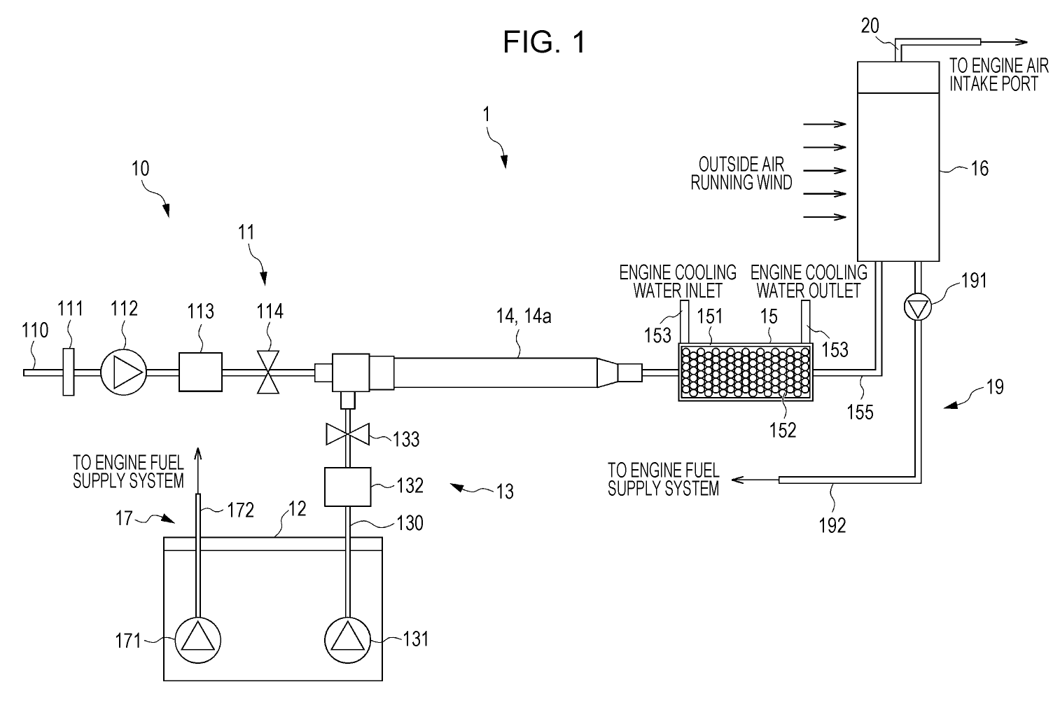

FIG. 1 is a drawing showing a configuration of a fuel reforming apparatus 1 according to an embodiment of the present application. The fuel reforming apparatus 1 according to the embodiment is mounted in a vehicle (not shown) and reforms hydrocarbons contained in fuel into alcohols on a vehicle and supplies the alcohols to an engine (not shown) according to the requirement of the engine.

The fuel reforming apparatus 1 according to the embodiment uses gasoline as the fuel and uses air as an oxidant. That is, the fuel reforming apparatus 1 according to the embodiment reforms the gasoline by oxidation reaction using oxygen in the air, and thus the gasoline can be reformed at a low temperature under mild conditions as compared with, for example, reformation using decomposition reaction or the like. Therefore, a system configuration can be simplified and is suitable for on-demand driving on a vehicle.

As shown in FIG. 1, the fuel reforming apparatus 1 according to the embodiment includes an air inlet 11, a fuel tank 12, a fuel inlet 13, a mixer 14 (14a), a reformer 15, a condenser 16, a fuel supply part 17, a reformed fuel supply part 19, and a gas phase supply part 20. As described below, in the fuel reforming apparatus 1, a predetermined part of the condenser 16 constitutes a fuel tank part in which the reformed fuel is stored. The reformed fuel is supplied to an engine fuel supply system from the condenser 16 (the fuel tank part thereof) using a reformed fuel pump 191 through a reformed fuel pipe 192.

The air inlet part 11 is provided upstream the mixer (14a) described below and introduces air as the oxidant into the mixer 14 (14a).

The air inlet part 11 includes an air filter 111, an air pump 112, an air flowmeter 113, and an air valve 114 which are provided in order from the upstream side of the air inlet pipe 110.

The air inlet part 11 takes in air from the outside air through the air filer 111 by driving the air pump 112. Also, the air inlet part 11 introduces the taken air into the mixer 14 (14a) by opening the air valve 114.

An opening of the air valve 114 is regulated by an electronic control unit (not shown, hereinafter referred to as “ECU”) based on an air flow rate detected by the air flowmeter 113, and an amount of air introduced into the mixer 14 is adjusted by regulating the opening.

The fuel supply part 17 includes a fuel pump 171, a fuel supply pipe 172, and an injector (not shown). The fuel supply part 17 supplies the gasoline stored in the fuel tank 12 to an engine cylinder or air-intake port (not shown) fuel through the supply pipe 172 and the injector by driving the fuel pump 171.

An amount of gasoline supplied to the engine is controlled by regulating an injection amount of the injector by using the ECU.

The fuel inlet part 13 is provided upstream the mixer 14 described below and introduces gasoline as the fuel into the mixer 14.

The fuel inlet part 13 includes a reformation pump 131, a fuel flowmeter 132, and a fuel pump 133 which are provided in order from the upstream side of a fuel inlet pipe 130.

The fuel inlet part 13 introduces the gasoline stored in the fuel tank 12 into the mixer 14 by driving the reformation pump 131 and opening the fuel valve 133.

An opening of the fuel valve 133 is regulated by the ECU based on a fuel flow rate detected by the fuel flowmeter 132, and an amount of the gasoline introduced into the mixer 14 is adjusted by regulating the opening.

In the fuel reforming apparatus 1, a supply device 10 that supplies air and fuel into the mixer 14 (14a) includes the air inlet part 11 and the fuel inlet part 13 described above.

In the supply device 10, the air and fuel supplied to the mixer 14 are adjusted by cooperation of the air inlet part 11 and the fuel inlet part 13 under control by the ECU so that the ratio of the fuel is 22% by weight or more.

The adjustment brings the ratio of the fuel in the air and fuel supplied to the mixer 14 to 22% by weight or more. The ratio corresponds to a fuel-rich region above the explosion limit. Therefore, the possibility of causing excessively rapid reaction is minimized, and the conversion process for converting the gasoline into alcohols is stabilized.

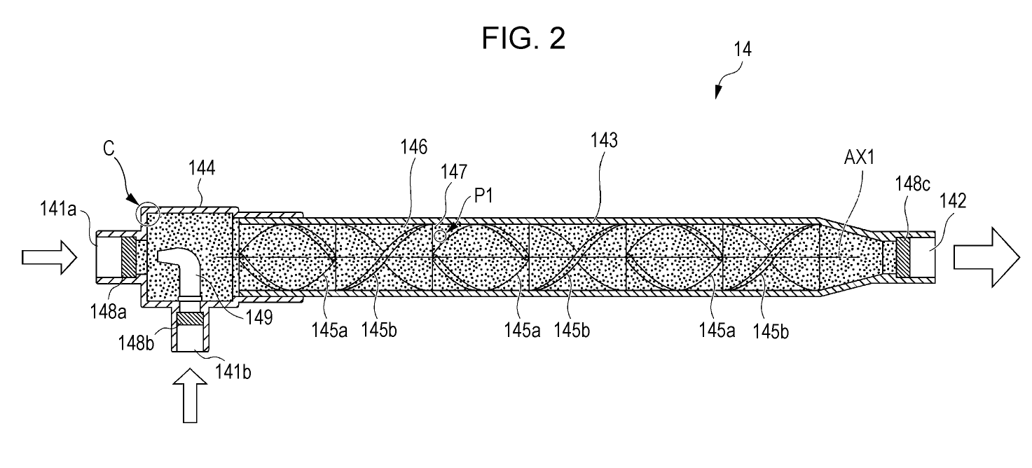

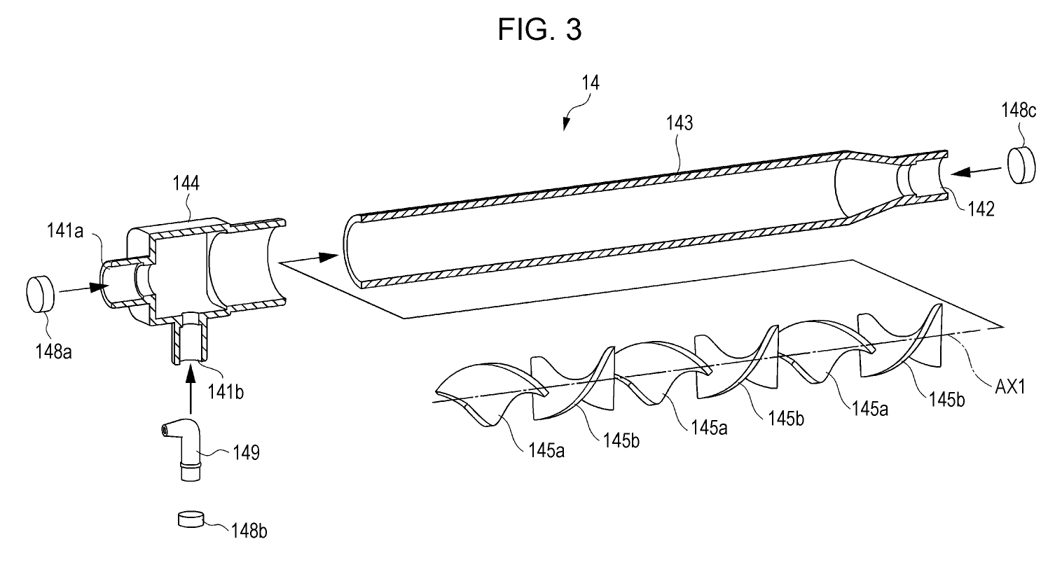

In the fuel reforming apparatus 1 according to the embodiment, the mixer 14 (14a) also has a characteristic in its configuration. FIG. 2 is a cross-sectional side view of the mixer 14 in an aspect used in the fuel reforming apparatus 1 according to the embodiment shown in FIG. 1. FIG. 3 is an exploded perspective view of the mixer shown in FIG. 2. In FIGS. 2 and 3, the same part is denoted by the same reference numeral.

In FIGS. 2 and 3, the mixer 14 includes two inlets including an air inlet 141a that is one of the fluid inlets and a fuel inlet 141b that is the other fluid inlet. The mixer 14 according to the embodiment includes one fluid outlet 142 for the two fluid inlets.

A casing 143 having a substantially tubular shape as a whole which extends in an axis AX1 direction is provided between the two fluid inlets 141a and 141b and the fluid outlet 142. In an example shown in the drawings, the two fluid inlets 141a and 141b are provided in a cap part 144 fitted to the start end (fluid-inlet-side end) of the casing 143, and the fluid outlet 142 is provided on the terminal side of the casing 143.

In addition, a plurality (in the example shown in the drawings, six) of fixed stirring blades 145a and 145b are provided to align in the axis AX1 direction in the casing 143. The fixed stirring blades 145a and 145b have two types of torsional turning directions including the first turning-type stirring blade 145a which is twisted to turn in the clockwise direction and the second turning-type fixed stirring blade 145b which is twisted to turn in the counterclockwise direction with changes in the position in the axis AX1 direction as viewed to the fluid outlet side (the side provided with the fluid outlet 142) from the fluid inlet side (the side provided with the fluid inlets 141a and 141b).

The two types of the stirring blades 145a and 145b are arranged alternately in order along the axis AX1 direction. In the example shown in the drawings, the adjacent stirring blades are connected to each other at the axial position to constitute a series of stirring blades.

The first turning-type stirring blades 145a and the second turning-type stirring blade 145b are arranged alternately in order along the axis AX1 direction. Therefore, the torsional turning directions of the stirring blades are sequentially reversed in the order of alignment.

In the embodiment, the space including the inside of the cap part 144 and the inside of the casing 143 and extending from the fluid inlets 141a and 141b to the fluid outlet 142 constitutes a housing part 146 set to house the plurality (in the example, a total of six) of fixed stirring blades 145a and 145b.

The entire remaining space of the housing part 146 that houses the fixed stirring blades 145a and 145b is finely filled with a particle material 147. That is, the particle material 147 is disposed to completely fill the entire remaining space of the housing part 146.

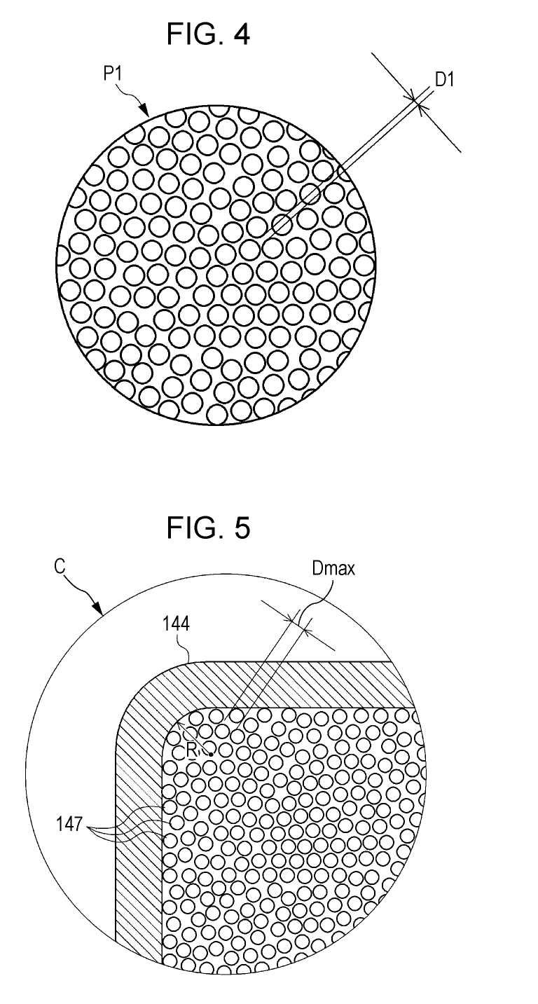

FIG. 4 is an enlarged schematic view showing a portion P1 in the housing part 146 of the mixer 14 shown in FIG. 2.

In particular, in the embodiment, the size D1 of gaps produced by fine filling of the particle material 147 in the entire remaining space is less than the quenching distance of the fuel (for example, gasoline) supplied from the fuel inlet 141b. The size D1 of the gaps is an average size (distance) of particle distances of the particle material 147 and the gap between the particles and the inner wall of the housing part 146.

The quenching distance is a theoretical property of flame propagation and represents a distance or diameter (of a predetermined shape) which causes no flame propagation because a heat loss to surroundings is more than the heat generated by chemical combustion reaction.

Therefore, excessively rapid reaction is not produced in the mixer 14, thereby causing the stable conversion process for converting the gasoline into alcohols.

FIG. 5 is an enlarged schematic view showing a corner C (FIG. 2) inside the housing part 146 described above. The corner C shown in FIG. 5 is a corner corresponding to the inside of the cap part 144 on the inside of the housing part 146. In a technical idea, the “corner” represents all corners in the housing part 146 and is representatively shown in the drawing.

As shown in FIG. 5, the R dimension of the inside corner C is equivalent to or more than the maximum diameter dimension Dmax of the particle material 147 finely filling the housing part 146. As a result, the dimension of a gap produced at the corner C does not exceed the quenching distance of the fuel (for example, gasoline) supplied from the fuel inlet 141b. That is, there is no possibility of producing a communication space of a dimension exceeding the quenching distance. Therefore, in the fuel reforming apparatus 1 according to the embodiment, the possibility of causing excessively rapid reaction in the mixer 14 is securely prevented.

Further, in the embodiment, the plurality of fixed stirring blades 145a and 145b are provided so that the gap between the stirring blades and the inner surface of the housing part 146 is less than the quenching distance of the fuel supplied from the fuel inlet. As a result, there is no possibility that the gap between the plurality of stirring blades 145a and 145b and the inner surface of the housing part 146 forms a communication space of a dimension exceeding the quenching distance. Therefore, in the fuel reforming apparatus 1 according to the embodiment, the possibility of causing excessively rapid reaction in the mixer 14 is securely prevented.

As shown in FIGS. 2 and 3, a filter 148a made of a porous material is fitted into the air inlet 141a of the cap part 144. Also, a filter 148b made of a porous material is fitted into the fuel inlet 141b of the cap part 144. Further, a filter 148c made of a porous material is fitted into the fuel outlet 142 of the casing 143.

The filters 148a, 148b and 148c are porous materials constituting partition members that partition between the housing part 146 and the air inlet 141a, the fuel inlet 141b, and the fluid outlet 142, respectively. The pore size of any one of the porous materials is equivalent to or smaller than the maximum diameter dimension Dmin of the particle material finely filling the housing part 146. Therefore, the possibility of outflow of the particle material 147 filling the housing part 146 is securely prevented.

In finely filling the remaining space of the housing part 146 with the particle material 147, for example, the housing part 146 in a state of being closed with the filters 148a and 148b on one of the sides is filled with the particle material 147 from the open fluid outlet 142 while vibration is applied to the particle material 147 (directly to the casing 143). After sufficiently fine filling, the fluid outlet 142 is sealed by fitting the filer 148c.

Alternatively, in contract to the above, first the fluid outlet 142 is sealed with the filter 148c, and the space is filled with the particle material 147 from the inlet not fitted with any one of the filers 148a and 148b. After sufficiently fine filling, the inlet is sealed with the corresponding filter.

In addition, as shown in FIGS. 2 and 3, the air inlet 141a which is one of the fluid inlets of the cap part 144 is provided so as to introduce air to the axis AX1 direction of the casing 143, and the fuel inlet 141b which is the other fluid inlet is provided downstream the air inlet 141a so as to introduce the fuel from a direction crossing the axis AX1 direction of the casing 143.

Further, a fuel nozzle 149 is provided so as to eject, toward the air inlet 141a, the fuel introduced from the fuel inlet 141b. As shown in the drawings, the fuel nozzle 149 has a bent pipe part in which the direction is changed to the axis AX1 direction from a direction (in the example, a direction perpendicular to) crossing the axis AX1 direction of the casing 143 and a tapered ejection port is disposed at the tip side. In addition, the filer 148b is close contact with the entire periphery of a fuel inlet opening on the fuel inlet 141b side of the fuel nozzle 149. In the embodiment, the fuel is ejected toward the air inlet 141a from the fuel nozzle 149, and thus the fuel is effectively mixed with air.

In the mixer in the aspect described above with reference to FIGS. 2 to 5, a series of plural fixed stirring blades (145a and 145b) is provided in the axis AX1 direction in the housing part 146 disposed in the mixer, and the remaining space is closely filled with the particle material. Therefore, fluids (air and fuel) introduced from the two fluid inlets (the air inlet 141a and the fuel inlet 141b) are uniformly mixed by active flow dispersion, change, turning (rotation) which are caused by interaction between the particle material and a static mixer configured by the fixed stirring blades (145a and 145b). The gaps produced in the housing part 146 also serve as a fluid passage and, as described above, the size thereof is less than the quenching distance. Therefore, in the mixer 14, the possibility of causing excessively rapid reaction is sufficiently suppressed.

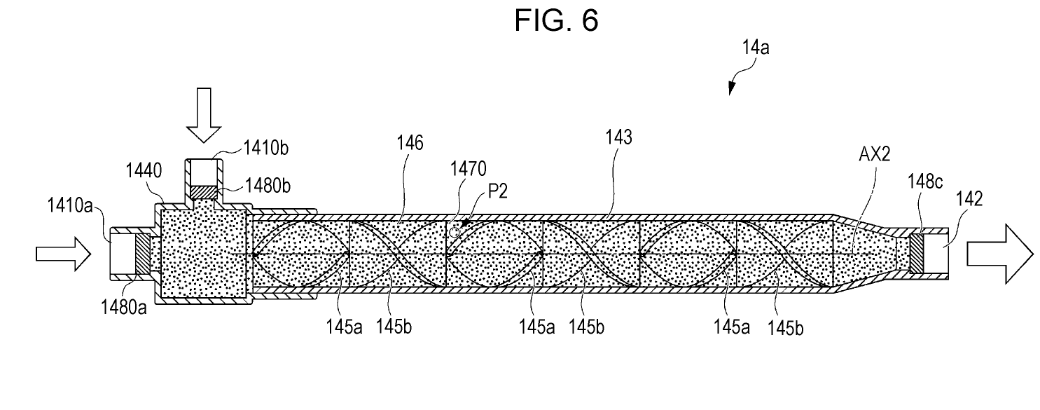

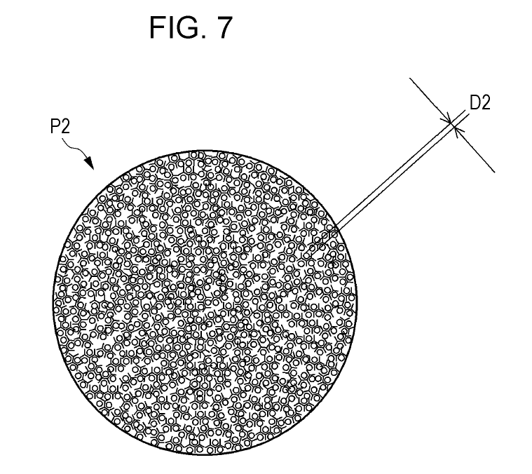

Next, a mixer in another aspect is described with reference to FIGS. 6 and 7. In FIG. 7, the same portions as in FIGS. 2 and 3 are denoted by the same reference numerals, and detailed description thereof is omitted.

A mixer 14a shown in FIG. 6 includes a plurality of fixed stirring blades 145a and 145b which are provided to align in an axis AX2 direction in a casing 143 fitted with a cap part 1440 on the start end side and provided with a fluid outlet 142 on the terminal end side so that the torsional turning direction is sequentially reversed in the order of alignment.

The cap part 1440 includes an air inlet 1410a which is one of fluid inlets and introduces air in the axis AX2 direction and a fuel inlet 1410b which is the other fluid inlet and introduces fuel from above in a direction (in this example, a direction perpendicular to) crossing the axis AX2 direction.

The mixer 14a is the same as the aspect shown in FIGS. 2 and 3 in that filters 1480a, 1480b, and 148c made of porous materials are fitted into the air inlet 1410a, the fuel inlet 1410b, and the fluid outlet 142, respectively.

Also, in the mixer 14a shown in FIG. 6, a space including the inside of the cap part 1440 and the inside of the casing 143 and extending from the fluid inlets (1410a and 1410b) of the cap part 1440 to the fluid outlet 142 of the casing 143 constitutes a housing part 146 which is set to house the plurality (in the example, six) of fixed stirring blades 145a and 145b. In the mixer 14a shown in FIG. 6, a porous material 1470 is disposed to completely fill the entire remaining space in the housing part 146.

FIG. 7 is an enlarged schematic view of a portion P2 in the housing part 146 of the mixer 14a shown in FIG. 6.

In this embodiment, in particular, the size (often the pore size of the porous material 1470, that is, the average diameter of the porous material 1470) D2 of gaps produced in the entire remaining space in a state in which the porous material 1470 is disposed is less than the quenching distance of the fuel (for example, gasoline) supplied from the fuel inlet 1410b.

In the mixer 14a in the aspect described with reference to FIGS. 6 and 7, a series of plural fixed stirring blades is provided in the axis AX2 direction in the housing part 146, and the porous material 1470 is disposed to completely fill the entire remaining space in the housing part 146. Therefore, fluids (air and fuel) introduced from the two fluid inlets (the air inlet 1410a and the fuel inlet 1410b) are uniformly mixed by active flow dispersion, change, turning (rotation) which are caused by interaction between the porous material and a static mixer configured by the fixed stirring blades (145a and 145b). The gaps produced in the housing part 146 also serve as a fluid passage and, as described above, the size thereof is less than the quenching distance. Therefore, in the mixer 14a, the possibility of causing excessively rapid reaction is sufficiently suppressed.

Also in the mixer 14a shown in FIG. 6, a cap part 144 including a fuel nozzle 149 provided therein as shown in FIGS. 2 and 3 may be applied in place of the cap part 1440. In this case, the air and the fuel are more effectively mixed by the fuel nozzle 149 that ejects the fuel toward the air inlet.

In the mixer 14a shown in FIG. 6, the porous material 1470 may be disposed so as to completely fill the entire remaining space in the housing part 146 by, for example, a method of pressing a foamed liquid such as a foamed resin from the air inlet 1410a, the fuel inlet 1410b, or the fluid outlet 142 in an open state, an then solidifying the liquid in the space. Alternatively, a fluid resin may be filled and then made porous by mixing with air or a foaming agent.

The mixer 14 (14a) may be configured to include, for example, a heater (not shown) so that the gasoline and the air are mixed while being heated to a predetermined temperature by the heater to produce an air-fuel mixture of the gasoline and air.

The casing 143 of the mixer 14 (14a) may be formed in a tapered shape in which the diameter gradually decreases in the axis AX1 (AX2) direction from the start end side fitted with the cap part 144 (1440) to the terminal end provided with the fluid outlet 142. In this case, when a series of plural fixed stirring blades (the first turning-type stirring blade 145a and the second turning-type stirring blade 145b) is provided in the casing 143 in a production process, handling is facilitated, thereby causing suitability for mass production.

The reformer 15 provided in a stage after the mixer 14 or 14a (hereinafter, simply referred to as “the mixer 14”) reforms, by using the air in the air-fuel mixture, the hydrocarbon as the main component of the gasoline in the air-fuel mixture supplied from the mixer 14 to produce alcohols. Specifically, the reformer 15 may be a flow reactor or a complete mixing reactor.

The flow reactor is a reactor in which the air-fuel mixture of the gasoline and the air introduced from the mixer 14 is reformed and flown out while being forced to flow as in a piston without being mixed with the air-fuel mixtures supplied previously and subsequently. The flow reactor has the property that the fluid flown out from the reactor and the fluid in the reactor have different compositions, and the residence time of the air-fuel mixture in the reactor has small variation.

On the other hand, the complete mixing reactor is a rector in which the air-fuel mixture of the gasoline and air introduced from the mixer 14 is uniformly mixed with a reaction product and reformed in the reformer. The complete mixing reactor has the property that the fluid flown out from the reactor and the fluid in the reactor have the same composition, and the residence time of the air-fuel mixture in the reactor has large variation.

In the fuel reforming apparatus 1 shown in FIG. 1, the reformer 15 includes a temperature sensor (not shown) and a cooling part 153 that cools the inside of the reformer 15. The cooling part 153 is controlled by ECU based on a temperature detected by the temperature sensor and cools the reformer 15 by supplying engine cooling water to the reformer 15.

The temperature of the engine cooling water is preferably 70° C. to 100° C. The temperature of the engine cooling water of less than 70° C. causes a low rate of reformation reaction, while the temperature of the engine cooling water of over 100° C. causes difficulty in using the engine cooling water. When the temperature in the reformer 15 reaches a high temperature because the reformation reaction proceeds, the cooling part 153 cools the reformer 15 with the engine cooling water, while when the temperature in the reformer 15 is a low temperature in an initial state of reformation reaction, conversely, the cooling part 153 functions to warm the reformer 15 with the engine cooling water.

The reformer 15 also includes a reformation catalyst 152 for reforming the hydrocarbons mainly contained in the gasoline by using the air as an oxidant to produce alcohols. Specifically, the reformer 15 includes a cylindrical casing 151 and a solid reformation catalyst 152 filling the casing 151.

The solid reformation catalyst 152 contains a micro-spherical porous carrier and a primary catalyst and an auxiliary catalyst which are carried on the surface of the porous carrier. The primary catalyst and auxiliary catalyst are carried in a uniformly mixed state on the surface of the micro-spherical porous carrier. The reformation catalyst 152 of the embodiment contains the micro-spherical porous carrier, and thus the surface area of the primary catalyst and auxiliary catalyst carried on the surface is increased, thereby increasing a contact area between gasoline as the fuel and air as the oxidant.

Examples of the micro-spherical porous carrier include silica beads, alumina beads, silica-alumina beads, and the like. Among these, silica beads are preferably used. The particle diameter of the porous carrier is preferably 3 μm to 500 μm.

The primary catalyst functions to produce alkyl radicals by abstracting hydrogen atoms from the hydrocarbons in the gasoline. Specifically, a N-hydroxyimide group-containing compound having a N-hydroxyimide group is used as the primary catalyst. In particular, N-hydroxyphthalimide (hereinafter, referred to as “NHPI”) or a NHPI derivative has a significant function.

The auxiliary catalyst has the ability of producing alcohols by reducing alkyl hydroperoxide produced from the alkyl radicals. Specifically, a transition metal compound is used as the auxiliary catalyst. In particle, a compound selected from the group consisting of cobalt compounds, manganese compounds, and copper compounds is preferably used. For example, cobalt(II) acetate or the like is used as a cobalt compound, manganese(II) acetate or the like is used as a manganese compound, and copper(I) chloride or the like is used as a copper compound.

A known impregnation method or the like is used as a method for carrying the primary catalyst and the auxiliary catalyst on the porous carrier. For example, a slurry containing the primary catalyst and the auxiliary catalyst at a predetermined mixing ratio is prepared, and then the micro-spherical porous carrier is immersed in the prepared slurry. Then, the porous slurry is pulled up from the slurry, and the excessive slurry adhering to the surface of the porous carrier is removed, followed by drying under predetermined conditions. Consequently, the reformation catalyst 152 containing the primary catalyst and the auxiliary catalyst which are uniformly carried on the porous carrier is preferred.

Here, reformation reaction which proceeds in the reformer 15 is described in detail below.

First, the reformation reaction of the embodiment is started by hydrogen abstraction reaction of abstracting hydrogen atoms from the hydrocarbons in the gasoline to produce alkyl radicals according to reaction formula (1) below. The hydrogen abstraction reaction proceeds by the action of the primary catalyst, radials, oxygen molecules, etc.

RH→R. Reaction formula (1)

[In the reaction formula (1), RH represents hydrocarbon, and R. represents alkyl radical.]

Next, the alkyl radicals produced by the hydrogen abstraction reaction are bonded with oxygen molecules to produce alkylperoxy radicals according to reaction formula (2) below.

R.+O₂→ROO. Reaction formula (2)

[In the reaction formula (2), O₂ represents oxygen molecule, and ROO. represents alkylperoxy radical.]

Next, the alkylperoxy radicals produced by the reaction formula (2) abstract hydrogen atoms from the hydrocarbons contained in the gasoline to produce alkyl hydroperoxide according to reaction formula (3) below.

ROO.+RH→ROOH+R. Reaction formula (3)

[In the reaction formula (3), ROOH represents alkyl hydroperoxide.]

Next, the alkyl hydroperoxide produced by the reaction formula (3) is reduced to an alcohol by the action of the auxiliary catalyst according to reaction formula (4) below.

ROOH→ROH Reaction formula (4)

[In the reaction formula (4), ROE represents an alcohol.]

Further, the alkyl hydroperoxide produced by the reaction formula (3) is decomposed into alkoxy radicals and hydroxy radicals by the action of the auxiliary catalyst or heat according to reaction formula (5) below.

ROOH→RO.+.OH Reaction formula (5)

[In the reaction formula (5), RO. represents alkoxy radical, and .OH represents hydroxy radical.]

Next, the alkoxy radicals produced by the reaction formula (5) abstract hydrogen atoms from a hydrocarbon contained in the gasoline to produce an alcohol.

RO.+RH→ROH+R. Reaction formula (6)

As described above, the hydrocarbon mainly contained in the gasoline is oxidatively reformed and converted to an alcohol. In further detail, the hydrocarbon contained in the gasoline is a hydrocarbon having 4 to 10 carbon atoms, and thus the hydrocarbon is converted to an alcohol having 4 to 10 carbon atoms. Thus, the fuel reforming apparatus 1 of the embodiment can improve the octane number of gasoline.

A condenser 16 is provided downstream the reformer 15 described above. The condenser 16 separates the gas produced from the reformer 15 into a condensed phase mainly containing the reformed fuel and a gas phase. The condenser 16 separates, by cooling, the produced gas supplied from the reformer 15 through a produced gas supply pipe 155 into the condensed phase mainly containing the reformed fuel and the gas phase. The materials in the condensed phase contain by-products, such as water, as well as the reformed fuel mainly composed of alcohols, and the materials in the gas phase contain nitrogen, oxygen, and gas components as other by-products.

The condenser 16 includes a double container (not shown) including an inner container and an outer container, and a mixed fluid running up in a mixed fluid flowing part which is a gap between the inner container and the outer container is cooled by the outer container functioning as a cooler and is separated into the condensed phase and the gas phase by an inner gas-liquid separating part. The bottom of the double container constitutes a reformed fuel tank part that stores the reformed fuel. That is, the condenser 16 also has the function as a reformed fuel tank.

The fuel reforming apparatus 1 according to the embodiment having the configuration described above is controlled by the ECU and operates as follows.

First, when it is determined that the gasoline is required to be reformed according to engine drive conditions, it is determined whether or not the temperature of the engine cooling water is the predetermined temperature or more. When the temperature of the engine cooling water is lower than the predetermined temperature immediately after engine starting, the reformed fuel stored in the reformed fuel tank part of the condenser 16 during previous reformation is supplied to an engine air-intake port through a reformed fuel pump 191.

On the other hand, when the temperature of the engine cooling water is the predetermined temperature or more, the fuel valve 133 and the air valve 114 are opened. Next, the gasoline is pressure-supplied from the fuel tank 12 through the reformation pump 131 and introduced into the mixer 14. At the same time, the air passed through the air filter 111 is introduced into the mixer 14 through the air pump 112.

In the fuel reforming apparatus 1 according to the embodiment, the air inlet 11 and the fuel inlet 13 in the supply device 10 are cooperated with each other under control by the ECU to adjust the air and the fuel supplied to the mixer 14 so that the ratio of the fuel (gasoline) is 22% by weight or more.

Also, the opening of each of the fuel valve 133 and the air valve 114 is feedback-controlled under control by the ECU based on the gasoline flow rate monitored by the fuel flowmeter 132 and the air flow rate monitored by the air flowmeter 113 so as to obtain a desired proper reformation reaction time.

Next, the gasoline and the air introduced into the mixer 14 are uniformly mixed while being heated to a predetermined temperature to produce the air-fuel mixture which is then supplied to the reformer 15. The hydrocarbon as the main component of the gasoline in the air-fuel mixture supplied into the reformer 15 is converted to alcohols by proceeding of reaction according to the reaction formulae (1) to (6) due to the action of the reformation catalyst 152. In this case, the supply of the engine cooling water is controlled based on the temperature monitored by the temperature sensor. Therefore, the temperature in the reformer 15 is maintained at the desired proper temperature.

Next, the gas produced in the reformer 15 is separated into the condensed phase and the gas phase by the condenser 16. The separated condensed phase mainly contains the alcohols of the reformed fuel, and the reformed fuel is stored in the reformed fuel tank part provided on the bottom side of the condenser 16. The reformed fuel in the reformed fuel tank part is supplied to the engine air-intake port through the reformed fuel pump 191. On the other hand, the gas-phase material separated is introduced into the engine air-intake port through a gas phase supply part 20 and thus supplied to combustion in the engine cylinder.

When it is determined that the gasoline is not required to be reformed according to the engine drive conditions, first the air pump 112 is stopped, and the air valve 114 is closed to stop the supply of air into the mixer 14. Next, after the reformer 15 is filled with the gasoline to completely flow out the air, the reformation pump 131 is stopped, and the fuel valve 133 is closed to stop the supply of the gasoline into the mixture 14. This avoids the situation in which the reformation reaction proceeds by the oxygen remaining in the reformer 15 during stop of the engine.

The fuel reforming apparatus 1 according to the embodiment exhibits the following effects.

(1) The fuel reforming apparatus 1 according to the embodiment includes the mixer 14 that mixes fuel mainly composed of hydrocarbons with air and supplies the mixture to the reformer 15, the reformer 15 that reforms the fuel with air and produces alcohols, and the condenser 16 that separates the gas produced by the reformer 15 into the condensed phase and the gas phase, the mixer 14, the reformer 15, and the condenser 16 being provided in order from the upstream side.

In particular, the mixer 14 includes two or more fluid inlets including the air inlet 141a and the fuel inlet 141b and one or more fluid outlets including the fluid outlet 142, the casing 143 with a substantially tubular shape as a whole extending in the axial direction between the air inlet 141a and the fuel inlet 141b as the fluid inlets and the fluid outlet 142, a plurality (for example a total of six) of fixed stirring blades, for example, the first turning-type stirring blade 145a and the second turning-type stirring blade 145b, provided to align in the axial direction in the casing 143 so that the torsional turning direction is sequentially reversed in the alignment order, and the particle material 147 or porous material 1470 disposed to completely fill the entire remaining space of the housing part 146 which is set to house at least the plurality of fixed stirring blades, for example, the first turning-type stirring blade 145a and the second turning-type stirring blade 145b, in the space including the inside of the casing 143 and extending from the air inlet 141a and the fuel inlet 141b as the fluid inlets to the fluid outlet 142. The size of the gaps produced in the entire remaining space in which the particle material 147 or porous material 1470 is disposed is less than the quenching distance of the fuel supplied from the fuel inlet 141b as the fluid inlet.

In the fuel reforming apparatus 1 described above in (1), fluids (air and fuel) introduced from the two fluid inlets (the air inlet 141a and the fuel inlet 141b) are uniformly mixed by active flow dispersion, change, turning (rotation) which are caused by interaction between the particle material and a static mixer configured by the fixed stirring blades (145a and 145b). In this case, the gaps produced in the housing part 146 also serve as a fluid passage and has a size of less than the quenching distance. Therefore, in the mixer 14, the possibility of causing excessively rapid reaction is sufficiently suppressed, thereby causing the stable conversion process for converting the gasoline into alcohols.

(2) In the fuel reforming apparatus 1 according to the embodiment, a corner (the portion C in FIG. 2 and FIG. 5) of the inner surface of the housing part 146 in the mixer 14 has the R dimension equivalent or larger than the maximum diameter dimension (Dmax shown in FIG. 5) of the particle material 147.

Therefore, when the particle material 147 is disposed in the housing part 146 of the mixer 14, the gaps exceeding the quenching distance of the fuel supplied from the fluid inlet 141b as the fluid inlet are not produced at the corner of the inner surface of the housing part 146. That is, there is no possibility of producing a communication space of a dimension exceeding the quenching distance. Therefore, the possibility of causing excessively rapid reaction is securely prevented.

(3) Also, in the fuel reforming apparatus 1 according to the embodiment, the first tuning-type stirring blade 145a and the second turning-type stirring blade 145b as the plurality of fixed stirring blades are provided in the mixer 14 so that the gap from the inner surface of the housing part 146 is less than the quenching distance of the fuel supplied from the fluid inlet 141b as the fluid inlet.

Therefore, there is no possibility that the gap between the plurality of fixed stirring blades (145a and 145b) and the inner surface of the housing part 146 forms a communication space of a dimension exceeding the quenching distance. Therefore, the possibility of causing excessively rapid reaction is securely prevented.

(4) In the fuel reforming apparatus 1 according to the embodiment, the mixer 14 includes the porous material partition member (the filters 148a, 148b, and 148c) that partitions between the air inlet 141a and the fluid inlet 141b as the fluid inlets and/or the fluid outlet 142 and the housing part 146. Therefore, when the housing part 146 is filled with the particle material 147, the possibility of outflow of the particle material 147 is securely prevented.

(5) In the fuel reforming apparatus 1 according to the embodiment, in the mixer 14, one of the fluid inlets constitutes the air inlet 141a that introduces air to the axial direction of the casing 143, the other fluid inlet constitutes the fuel inlet 141b that introduces the fuel from a direction crossing the axis of the casing 143 on the downstream side of the air inlet 141a, and further the fuel nozzle 149 is provided for ejecting the fuel introduced from the fuel inlet 141b toward the air inlet 141a.

Therefore, the fuel is effectively mixed with air by the fuel nozzle that ejects the fuel toward the air inlet.

(6) The fuel reforming apparatus 1 according to the embodiment further includes the supply device 10 that supplies air and the fuel to the mixer 14 (14a), and the ratio of the fuel is adjusted, by the supply device 10, to 22% by weight or more relative to the total amount of the air and fuel.

Therefore, the ratio of the fuel is 22% by weight or more relative to the total amount of the air and fuel supplied to the mixer 14 (14a), and the ratio corresponds to a fuel-rich region above the explosion limit. Therefore, the possibility of causing excessively rapid reaction is minimized, thereby stabilizing the conversion process for converting the gasoline into alcohols.

The present application is not limited to the embodiment described below, and includes changes, modifications, etc. within a range in which the object of the present application can be achieved.

The applicant has recently led to the proposal of a fuel reforming apparatus capable of converting gasoline mainly composed of hydrocarbons into alcohols on a vehicle (Japanese Patent Application No. 2013-240400).

The fuel reforming apparatus proposed by the applicant includes a mixer that mixes fuel mainly composed of hydrocarbons with air and supplies the mixture to a reformer, the reformer that reforms the fuel with air and generates alcohols, and a condenser that separates the gas produced by the reformer into a condensed phase and a gas phase, the mixer, the reformer, and the condenser being provided in order from the upstream side.

The reformer in the fuel reforming apparatus contains a primary catalyst functioning to abstract hydrogen atoms from the hydrocarbons in the fuel and generate alkyl radicals, and an auxiliary catalyst functioning to reduce alkyl hydroperoxides produced from the alkyl radicals to produce alcohols.

The fuel reforming apparatus described above is desired to prevent a treatment process from being made unstable by excessive proceeding of reaction in the mixer that supplies the mixture of fuel and air to the reformer.

Recently, the applicant has made various researches on the mixer disposed upstream the reformer and obtained a solution for stabilizing the mixing treatment in the mixer.

The present application has been achieved through the process described above, and describes an excellent fuel reforming apparatus capable of converting a gasoline mainly composed of hydrocarbons into alcohols on a vehicle and further stabilizing the conversion process, and also describes a mixer used in the apparatus.

(1) A fuel reforming apparatus (for example, a fuel reforming apparatus 1 described below) reforms a fuel mainly composed of hydrocarbons by using air and generates alcohols. The fuel reforming apparatus includes a reformer (for example, a reformer 15 described below) containing a reforming catalyst that reforms the fuel mainly composed of hydrocarbons by using air and generates alcohols, a mixer (for example, a mixer 14 described below) that is provided on the upstream side of the reformer and mixes the fuel with air and supplies the mixture to the reformer, and a condenser (for example, a condenser 16 described below) that is provided on the downstream side of the reformer and separates the gas produced from the reformer into a condensed phase mainly composed of the reformed fuel and a gas phase. The mixer includes two or more fluid inlets (for example, an air inlet 141a and a fuel inlet 141b described below) and one or more fluid outlets (for example, a fluid outlet 142 described below), a casing (for example, a casing 143 described below) with a substantially tubular shape as a whole extending in the axial direction between the fluid inlets and the fluid outlets, a plurality of fixed stirring blades (for example, a first turning-type stirring blade 145a and a second turning-type stirring blade 145b described below) provided to align in the axial direction in the casing so that the torsional turning direction is sequentially reversed in the order of alignment, and a particle material (for example, a particle material 147 described below) or a porous material (for example, a porous material 1470 described below) disposed to fill the entire remaining space of a housing part (for example, a housing part 146 described below) that is set to house at least the plurality of fixed stirring blades in a space including the inside of the casing and that extends from the fluid inlets to the fluid outlets. The size of gaps produced in the entire remaining space in which the particle material or porous material is disposed is less than the quenching distance of the fuel supplied from the fluid inlets.

The fuel reforming apparatus described above in (1) includes the mixer that mixes the fuel mainly composed of hydrocarbons with air and supplies the mixture to the reformer, the reformer that reforms the fuel by using air and generates alcohols, and the condenser that separates the gas produced from the reformer into the condensed phase and the gas phase. In particular, the mixer includes two or more fluid inlets and one or more fluid outlets, the casing with a substantially tubular shape as a whole extending in the axial direction between the fluid inlets and the fluid outlets, the plurality of fixed stirring blades provided to align in the axial direction in the casing so that the torsional turning direction is sequentially reversed in the order of alignment, and the particle material or porous material disposed to fill the entire remaining space of the housing part that is set to house at least the plurality of fixed stirring blades in the space including the inside of the casing and that extends from the fluid inlets to the fluid outlets. The size of the gaps produced in the entire remaining space in which the particle material or porous material is disposed is less than the quenching distance of the fuel supplied from the fluid inlets.

Therefore, a conversion process for converting the gasoline into alcohols is stabilized without causing excessively rapid reaction.

In addition, the size of the gaps represents the average distance (average dimension) of the gaps between particles of the particle material or represents the average distance (average dimension) of pore diameters of the porous material.

(2) In the mixer of the fuel reforming apparatus described above in (1), a corner (for example, a portion C in FIG. 2 described below) of the inner surface of the housing part has a R dimension equivalent or larger than the maximum diameter dimension (for example, Dmax described below) of the particle material.

In the fuel reforming apparatus described above in (2), in particular, in the fuel reforming apparatus described above in (1), when the particle material is disposed in the housing part of the mixer, the gaps exceeding the quenching distance of the fuel supplied from the fluid inlets are not produced at the corner of the inner surface of the housing part. That is, there is no possibility of producing a communication space of a dimension exceeding the quenching distance. Therefore, the possibility of causing excessively rapid reaction is securely prevented.

(3) In the fuel reforming apparatus described above in (1) or (2), the plurality of fixed stirring blades are provided in the mixer so that a gap from the inner surface of the housing part is less than the quenching distance of the fuel supplied from the fluid inlets.

In the fuel reforming apparatus described above in (3), particularly in the fuel reforming apparatus described above in (1) or (2), the gap between the plurality of fixed stirring blades in the mixer and the inner surface of the housing part is less than the quenching distance of the fuel supplied from the fluid inlets. As a result, there is no possibility that the gap between the plurality of fixed stirring blades and the inner surface of the housing part forms a communication space of a dimension exceeding the quenching distance. Therefore, the possibility of causing excessively rapid reaction is securely prevented.

(4) In the fuel reforming apparatus described above in any one of (1) to (3), the mixer includes a porous material partition member (for example, filters 148a, 148b, and 148c described below) that partitions between the fluid inlets and/or the fluid outlets and the housing part.

In the fuel reforming apparatus described above in (4), particularly in the fuel reforming apparatus described above in any one of (1) to (3), when the particle material is housed in the housing part, the possibility of outflow of the particle material filling the housing part is securely prevented by the porous material partition member that partitions between the fluid inlets and/or the fluid outlets and the housing part in the mixer.

(5) In the fuel reforming apparatus described above in any one of (1) to (4), in the mixer, one of the fluid inlets constitutes an air inlet (for example, an air inlet 141a described below) that introduces air to the axial direction of the casing, the other fluid inlet constitutes a fuel inlet (for example, a fuel inlet 141b described below) that introduces the fuel from a direction crossing the axis of the casing on the downstream side of the air inlet, and further a fuel nozzle (for example, a fuel nozzle 149 described below) is provided for ejecting the fuel introduced from the fuel inlet toward the air inlet.

In the fuel reforming apparatus described above in (5), particularly in the fuel reforming apparatus described above in any one of (1) to (4), the fuel is effectively mixed with air by the fuel nozzle that ejects the fuel toward the air inlet.

(6) The fuel reforming apparatus described above in any one of (1) to (5) further includes a supply device (for example, a supply device 10 described below) that supplies air and the fuel to the mixer, and the ratio of the fuel is adjusted, by the supply device, to 22% by weight or more relative to the total amount of the air and fuel.

In the fuel reforming apparatus described above in (6), particularly in the fuel reforming apparatus described above in any one of (1) to (5), the ratio of the fuel is 22% by weight or more relative to the total amount of the air and fuel supplied to the mixer, and the ratio corresponds to a fuel-rich region above an explosion limit. Therefore, the possibility of causing excessively rapid reaction is minimized, thereby stabilizing the conversion process for converting the gasoline to alcohols.

According to the present disclosure, it is possible to realize an excellent fuel reforming apparatus capable of converting gasoline mainly composed of hydrocarbons to alcohols on a vehicle and further stabilizing a conversion process, and also realize a mixer used in the apparatus.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel reforming apparatus comprising:
a reformer containing a reforming catalyst that reforms a fuel mainly composed of a hydrocarbon by using air and produces an alcohol;
a mixer that is provided on the upstream side of the reformer, mixes the fuel with air, and supplies the mixture to the reformer; and
a condenser that is provided on the downstream side of the reformer and separates the gas produced from the reformer into a condensed phase mainly composed of the reformed fuel and a gas phase,
wherein the mixer includes two or more fluid inlets and one or more fluid outlets;
a casing with a substantially tubular shape as a whole extending in the axial direction between the fluid inlets and the fluid outlets;
a plurality of fixed stirring blades provided to align in the axial direction in the casing so that the torsional turning direction is sequentially reversed in the order of alignment; and
a particle material or a porous material disposed to fill the entire remaining space of a housing part that is set to house at least the plurality of fixed stirring blades in a space including the inside of the casing and that extends from the fluid inlets to the fluid outlets; and
the size of a gap produced in the entire remaining space in which the particle material or porous material is disposed is less than the quenching distance of the fuel supplied from the fluid inlets.

2. The fuel reforming apparatus according to claim 1, wherein in the mixer, a corner of the inner surface of the housing part has a R dimension equivalent or larger than the maximum diameter dimension of the particle material.

3. The fuel reforming apparatus according to claim 1, wherein the plurality of fixed stirring blades are provided in the mixer so that a gap from the inner surface of the housing part is less than the quenching distance of the fuel supplied from the fluid inlets.

4. The fuel reforming apparatus according to claim 1, wherein the mixer includes a porous material partition member that partitions between the fluid inlets and/or the fluid outlets and the housing part.

5. The fuel reforming apparatus according to claim 1, wherein in the mixer, one of the fluid inlets constitutes an air inlet that introduces air to the axial direction of the casing, the other fluid inlet constitutes a fuel inlet that introduces the fuel from a direction crossing the axis of the casing on the downstream side of the air inlet, and a fuel nozzle is further provided for ejecting the fuel introduced from the fuel inlet toward the air inlet.

6. The fuel reforming apparatus according to claim 1, further comprising a supply device that supplies air and the fuel to the mixer, and the ratio of the fuel is adjusted, by the supply device, to 22% by weight or more relative to the total amount of the air and fuel.

7. A fuel reforming apparatus comprising:
a reformer including a reforming catalyst to reform a fuel comprising a hydrocarbon using air to produce gas for obtaining an alcohol;
a condenser to separate the gas produced by the reformer into a gas phase and a condensed phase which comprises reformed fuel; and
a mixer to mix the fuel with air to produce a mixture which is supplied to the reformer, the mixer comprising:
plural fluid inlets;
at least one fluid outlet;
a casing having a substantially tubular shape extending in an axial direction of the casing between the plural fluid inlets and the at least one fluid outlet;
a plurality of stirring blades provided in the casing to align in the axial direction so that a torsional turning direction of the plurality of stirring blades is sequentially reversed in an order of alignment; and
a particle material or a porous material disposed in the casing to fill an entire space containing the plurality of stirring blades from the plural fluid inlets to the at least one fluid outlet, sizes of gaps existing in the entire space being less than a quenching distance of the fuel supplied from the plural fluid inlets.

8. The fuel reforming apparatus according to claim 7, wherein in the mixer, a corner of an inner surface of the casing has a R dimension equal to or larger than the maximum diameter dimension of the particle material.

9. The fuel reforming apparatus according to claim 7, wherein gaps between the plurality of stirring blades and an inner surface of the casing are less than the quenching distance of the fuel supplied from the fluid inlets.

10. The fuel reforming apparatus according to claim 7, wherein the mixer includes at least one of a first porous material partition member disposed between the fluid inlets and the plurality of stirring blades and a second porous material partition member disposed between the fluid outlets and the plurality of stirring blades.

11. The fuel reforming apparatus according to claim 7, wherein the plural fluid inlets comprises an air inlet to introduce air to the casing in the axial direction, and a fuel inlet to introduce the fuel from a direction crossing the axial direction between the air inlet and the plurality of stirring blades, and the mixer further comprises a fuel nozzle to eject the fuel introduced from the fuel inlet toward the air inlet.

12. The fuel reforming apparatus according to claim 7, further comprising a supply device to supply the air and the fuel to the mixer, and the ratio of the fuel is adjusted, by the supply device, to 22% by weight or more relative to the total amount of the air and the fuel.
